(19) United States
(12) Patent Application Publication
(10) Pub. No.: US 2003/0203730 A1
(43) Pub. Date: Oct. 30, 2003

(54) Location-based remote monitoring

(76) Inventors: Dadong Wan, Palatine, IL (US); Anatole V. Gershman, Chicago, IL (US); Krishna Rao, Evanston, IL (US)

Correspondence Address: VEDDER PRICE/ACCENTURE, 222 NORTH LASALLE STREET, CHICAGO, IL, 60601, US

(21) Appl. No.: 10/120,627

(22) Filed: Apr. 11, 2002

(51) Int. Cl. H04Q 7/20

(52) U.S. Cl. 455/404.2; 455/456.1

(57) ABSTRACT

A mobile wireless device provides location-related information to a remote monitoring position. Based on the location-related information, the remote monitoring position accesses one or more environmental sensors proximate to a location of the mobile wireless device. Thereafter, environmental information concerning a region proximate to the mobile wireless device's location is provided to the remote monitoring position. In turn, the remote monitoring position may present the environmental information to a user of the remote monitoring position and/or may send at least some of the environmental information to the mobile wireless device for presentation to the user of the mobile wireless device. Audio information may be sent by either or both of the mobile wireless device and the remote monitoring station, and alarm signals can be generated by either. In this manner, the present invention provides a technique whereby a virtual personal escort presence may be established in a cost-efficient manner.

### FIELD OF THE INVENTION

The present invention relates to a technique for remote monitoring and, in particular, to a technique for remote monitoring based on location of a mobile wireless device and environmental sensors proximate to the location of the mobile wireless device.

### BACKGROUND OF THE INVENTION

In today's society, the desire for improved security continues to grow, not only on an organizational level (as in the case, for example, of building or airport security) but also on a personal level. Various techniques currently exist for providing personal security, including personal escorts or so-called “bodyguards.” Personal escorts of this type are typically used by high-profile individuals who may be the subject of specific security risks, e.g., corporate executives or celebrities are, in some countries, often the target of kidnapping attempts or personal threats. While personal escorts are an effective means of responding to known or suspected security threats, they are a relatively expensive solution. As such, other types of individuals are typically unable to avail themselves of such protection, nor would they be inclined to incur such an expense given the lack of a specific security risk.

Other means for providing personal security are known in the art. For example, so-called “panic” devices are available that allow a user to activate a beacon or wireless communication device, thereby notifying security personnel of an emergency situation. Such devices are, in some instances, able to provide location information of the device itself (and, presumably, a user of the device) or allow such location information to be determined by security personnel such that aid may be directed in accordance with the location information. Such devices, however, do not provide the sense that one is being escorted. Indeed, it is up to the individual carrying the device to recognize the security threat and respond accordingly. At the opposite end of the spectrum, security cameras typically found around buildings or public areas allow security personnel to monitor relatively large areas and, by chance, individuals who may pass through such areas. However, such monitoring is not tailored to any one individual in the sense of a personal escort and, often, the security personnel performing such monitoring are unable to communicate with individuals being monitored.

Therefore, it would be advantageous to provide a technique that allows individuals to be effectively escorted without incurring the substantial expense typically resulting from personal escorts.

### BRIEF SUMMARY OF THE INVENTION

The present invention provides a technique for monitoring a mobile wireless device and, by implication, a user of the mobile wireless device, to thereby provide a virtual personal escort presence. To this end, the present invention employs a mobile wireless device that is capable of providing, or enabling the determination of, location-related information. When a user of the mobile wireless device desires such an escort service, he or she may input a request to the device. Based on the request, a suitable monitoring service provider is identified. Thereafter, location-related information corresponding to the mobile wireless device is provided to a remote monitoring position maintained by the service provider. Based on the location-related information, which may be directly provided by the mobile wireless device or otherwise ascertained, the remote monitoring position accesses one or more environmental sensors proximate to a location of the mobile wireless device. In a preferred embodiment, a registry of environmental sensors, organized in part based on their geographic location, is accessed by the remote monitoring position to identify the one or more environmental sensors used. The environmental sensors registered in this manner may comprise publicly available sensors or private sensors.

Environmental information concerning a region proximate to the mobile wireless device's location is provided to the remote monitoring position. In turn, the remote monitoring position may present the environmental information to a user of the remote monitoring position, e.g., security personnel, and/or may send at least some of the environmental information to the mobile wireless device for presentation to the user of the mobile wireless device. Additionally, audio information may be sent by either or both of the mobile wireless device and the remote monitoring station to the other. Further still, alarm signals can be generated by either. In yet another embodiment, the mobile wireless device may itself be equipped with an additional environmental sensor such that the mobile wireless device can provide additional environmental information to the remote monitoring position. In a presently preferred embodiment, the mobile wireless device and the remote monitoring position communicate with each other via a public and/or private communication network. In this manner, the present invention provides a technique whereby a virtual personal escort presence may be established in a cost-efficient manner.

### BRIEF DESCRIPTION OF THE DRAWINGS

The present invention is illustrated by way of example and not limited in the accompanying FIGS. in which like reference numerals indicate similar elements and in which:

FIG. 1 is a block diagram of a system in accordance with an embodiment of the present invention;

FIG. 2 is a block diagram of a mobile wireless device in accordance with an embodiment of the present invention;

FIG. 3 is a block diagram of a remote monitoring position in accordance with an embodiment of the present invention;

FIG. 4 is a flowchart illustrating service processing in accordance with an embodiment of the present invention;

FIG. 5 is a more detailed flowchart illustrating processing in accordance with an embodiment of the present invention;

FIG. 6 is a flowchart illustrating operation of a mobile wireless device in accordance with an embodiment of the present invention; and

FIG. 7 is a flowchart illustrating operation of a remote monitoring position in accordance with an embodiment of the present invention.

### DETAILED DESCRIPTION OF THE INVENTION

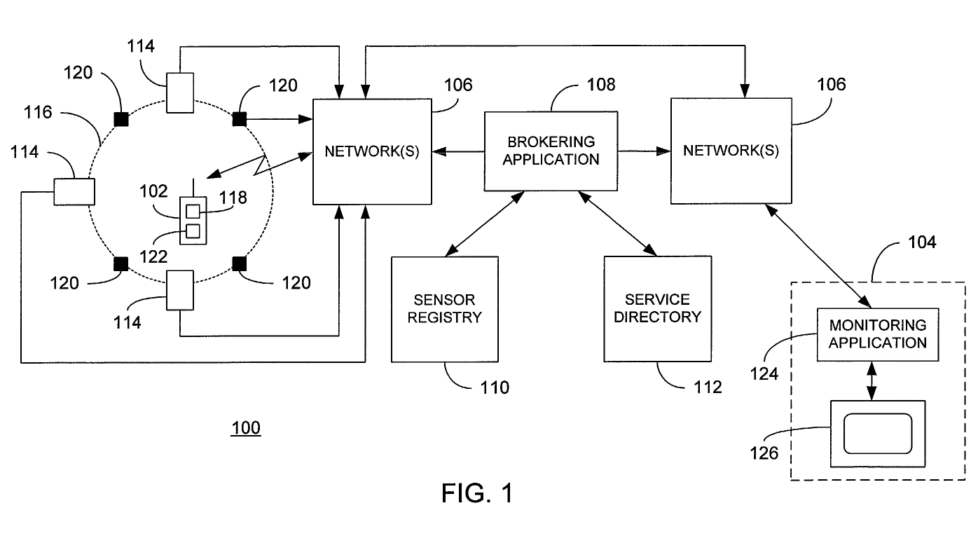

The present invention may be more readily described with reference to FIGS. 1-7. FIG. 1 illustrates a system 100 in accordance with an embodiment of the present invention. The system 100 comprises at least one mobile wireless device 102 and at least one remote monitoring position 104 (only one of each shown for clarity) capable of communicating with each other via one or more communication networks 106.

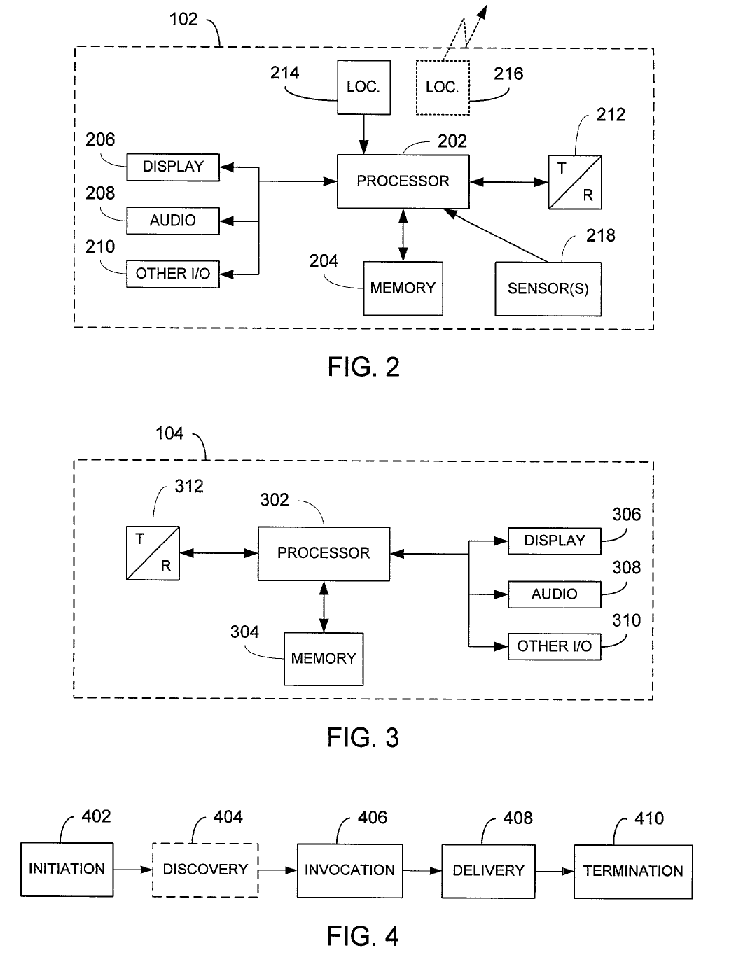

The mobile wireless device 102 (illustrated in greater detail in FIG. 2) may comprise any processor-based device capable of at least one-way wireless, and preferably two-way wireless, communication and capable of providing, or enabling the determination of, location-related information. For example, the mobile wireless device 102 may comprise a cellular telephone, personal digital assistant, portable computer or any similar device or combination thereof. In order to provide location-related information, the mobile wireless device 102 may comprise one or more components 118 capable of directly determining such information, e.g., a Global Positioning Satellite (GPS) receiver. In this manner, the mobile wireless device is capable of providing location information (e.g., latitude and longitude coordinates) as the location-related information directly. Alternatively, the device 102 may comprise elements 118 that allow the location information to be determined by another component. For example, a fixed positioning system 120, such as an in-building infra-red (IR) tracking system, within a region 116 proximate a location of the mobile wireless device 102 may be used to receive transmitted or reflected signals sent by the mobile wireless device 102 through a suitable IR element 118. Other positioning or tracking technologies include the so-called IEEE 802.11 standard (for both wireless communication and location tracking) and radio frequency identification (RFID) systems. The positioning system 120 thereafter determines suitable location information which may be obtained via the network(s) 106.

The remote monitoring position 104 comprises a monitoring application 124 and, in a preferred embodiment, a display device 126 capable of displaying images captured by a suitable environmental sensor (e.g., a full-motion video or still camera, or even webcams). As described in greater detail below, the monitoring application 124 preferably comprises software routines executed by a suitable processor-based platform implementing a service offered by a service provider. Information regarding such service and service provider can be listed in a service directory 112 along with information regarding other services provided by other service providers. A more detailed illustration of the remote monitoring position 104 is provided below with reference to FIG. 3.

The remote monitoring position 104, via the monitoring application 124, can receive environmental information from one or more environmental sensors 114 via the network(s) 106. The particular sensors used in any given situation is necessarily dependent upon the location of the mobile wireless device being monitored. Thus, a sensor registry 110 is provided which lists a plurality of environmental sensors indexed, at least in part, based upon the geographic location of each sensor. In a preferred embodiment, additional information regarding each sensor is also stored in the sensor registry 110, which additional information allows the remote monitoring position 104 to determine which sensors are suitable for use. For example, such additional information may include information regarding the capabilities of each sensor, particular protocols adhered to by each sensor, whether a fee is charged for usage of the sensor, etc. In one embodiment of the present invention, it is anticipated that entities (e.g., businesses, local governmental agencies, etc.) in possession of suitable environmental sensors (e.g., video cameras, etc.) may desire to make some or all of the environmental information (e.g., video streams, etc.) provided by their sensors available to others for a fee. To this end, such entities would be willing to populate the sensor registry 110 (which may be implemented as a suitable configured web server or the like) with the necessary information such that service providers can access their sensors.

As alluded to above, the environmental sensors 114 may comprise any type of sensor device capable of providing environmental data about a particular area with which they are associated. A primary example of such sensors are video or still cameras of the type commonly used in current surveillance systems given their relative ubiquity. Additionally, the use of video cameras and the like is attractive from the security point of view because they convey a substantial quantity of information that would be useful in identifying security risks. However, the present invention is not limited to image-based sensors. For example, sensors capable of monitoring various other environmental variables, such as heat, sound, moisture, air quality, vibration, radiation, etc. may be equally employed as a matter of design choice and the present invention is not limited in this regard. It should be further noted that the mobile wireless device 102 may itself comprise an environmental sensor 122, the use of which is described in greater detail below.

In one embodiment of the present invention, access to the sensor registry 110 and service directory 112 is controlled by a brokering application 108. Implemented as software routines executed by a suitable processor-based platform, the brokering application 108 acts as a central point whereby entities seeking monitoring services may obtain information about such services. It also directs traffic and provides such administrative functions like metering, payment, security, and quality assurance. To this end, the brokering application 108 obtains suitable information from the service directory 112 in response to request for service. Likewise, service providers are put in touch with potential recipients of their services, and provided access to the relevant sensor registries 110, by the brokering application 108. However, an implementation could be provided in which the brokering application 108 is not required. In this instance, the sensor registry 110 and service directly 112 would be directly accessible to the relevant parties via the network(s) 106.

As shown, the network(s) 106 provide communication paths between the various elements illustrated in FIG. 1. The network(s) 106 may comprise any private network, such as a local area network (LAN) or wide area network (WAN) provided by a private organization, a publicly-accessible network such as the so-called Internet or World Wide Web, or combinations of such private and public networks. As a result of the network(s) 106, the remote monitoring position 104 may, in fact, be quite remote relative to any given mobile wireless device 102 that it is servicing. For example, given the capability to transmit and receive streaming video and/or audio over public networks, it may be possible to locate the remote monitoring position 104 in different countries relative to those where its monitoring service is provided. Further still, the networks(s) 106 is not limited to wired communication resources, but also includes those elements necessary to enable wireless communications, for example, cellular radio networks providing gateway access to other wired networks. In this manner, the mobile wireless device 102 is able to communicate with the remote monitoring position 104.

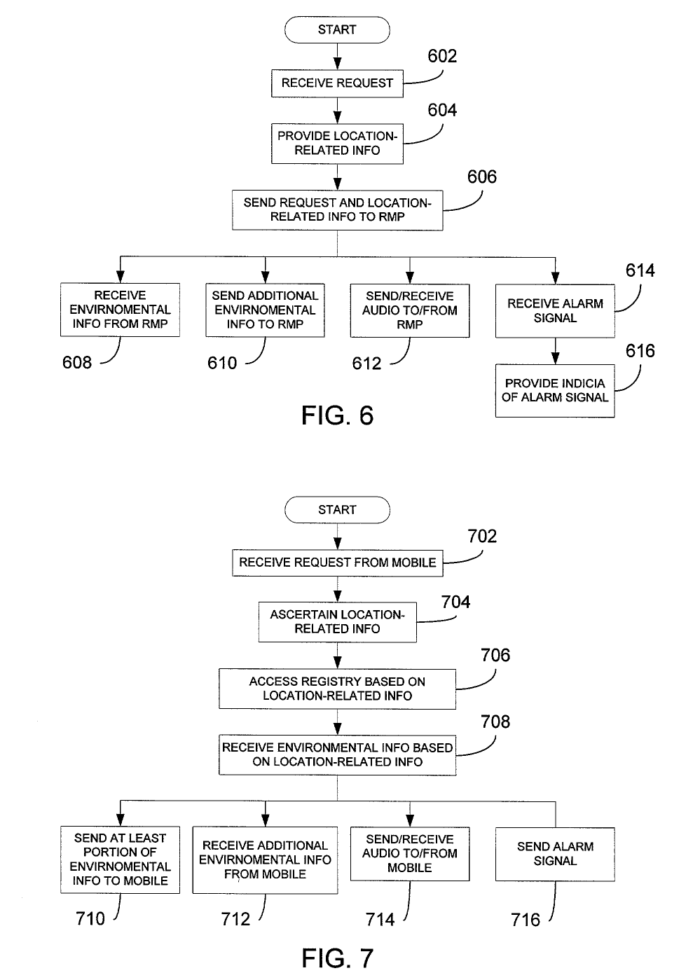

Referring now to FIG. 2, a more detailed illustration of a mobile wireless device 102 in accordance with an embodiment of the present invention is provided. In particular, the mobile wireless device 102 comprises a processor 202, such as a microprocessor, microcontroller, digital signal processor, etc. or combinations thereof, coupled to memory 204, which may comprise any combination of volatile and/or non-volatile digital storage devices such as random access memory (RAM), read only memory (ROM), hard drives, optical disks, etc. The memory 204 preferably has stored thereon software routines and the like in the form of instructions that are executable by the processor 202, which software routines implement the functionality described herein. Together, the processor 202 and memory 204 control the overall operation of the mobile wireless device. In particular, the processor 202 and memory 204 implement an application that synchronizes various communication channels with the brokering application and the monitoring application implemented by the remote monitoring position. Operation of such an is further described below with reference to FIG. 6.

Preferably, a display device 206, audio interface 208 and other input/output devices 210 are provided as shown. The display device 206 may comprise any suitable display screen for use in a mobile environment, such as those commonly found in PDAs or portable computers. The audio interface 208 comprises at least an audio output device, such as a speaker or annunciator, such that audio information can be provided to a user of the mobile wireless device 102. Additionally, a microphone may be provided as part of the audio interface 208 for the purpose of providing voice communications through the mobile wireless device. The other input/output devices 210 may comprises touch-screens, keyboards, keypads, buttons, lights, etc. that allow user input to be received and other forms of output to be provided to the users. In particular, the other input/output devices may be used to provide an alarm signal to be sent by the mobile wireless device to a remote monitoring position.

A wireless interface 212 is also provided to enable wireless communications, particularly with at least some portion of the network(s) 106. For example, the wireless interface 212 may comprise a cellular transceiver or a so-called Bluetooth transceiver or an IEEE 802.11 transceiver. The present invention is not limited with regard to the particular technology providing wireless communications. In general, however, the wireless interface 212 enable environmental information to be received or sent by the mobile wireless device 102 and, in a preferred embodiment, to transceive audio information as well.

As mentioned above, a location-determining device 214, such as a GPS receiver or a location-enabling device 216, such as an IR transmitter, IEEE 802.11 card, RFID tag, or other active device, is provided in each mobile wireless device 102. In this manner, each mobile wireless device 102 may either provide location-related information directly (as in the case of GPS latitude-longitude coordinates) or allow another system to determine the location-related information (as in the case of transmitted signals picked up by a tracking system).

Finally, one or more sensors 218 may be provided which sensors are capable of providing environmental data relative to the exact location of the mobile wireless device 102. Again, any type of sensor may be employed for this purpose as a matter of design choice.

Referring now to FIG. 3, a more detailed illustration of a remote monitoring position 104 in accordance with an embodiment of the present invention is provided. In particular, the remote monitoring position 104 comprises a processor 302, such as a microprocessor, microcontroller, digital signal processor, etc. or combinations thereof, coupled to memory 304, which may comprise any combination of volatile and/or non-volatile digital storage devices such as random access memory (RAM), read only memory (ROM), hard drives, optical disks, etc. The memory 304 preferably has stored thereon software routines and the like in the form of instructions that are executable by the processor 302, which software routines implement the functionality described herein, including the monitoring application 124. Together, the processor 302 and memory 304 control the overall operation of the remote monitoring position.

As in the case of the mobile wireless device 102, the remote monitoring position 104 is similarly equipped with a suitable display device 306, an audio interface 308 and other input/output devices 310. In particular, the other input/output devices 310 may be used to transmit an alarm signal to a mobile wireless device. Additionally, in a preferred embodiment, multiple display devices are provided to show multiple views of the same geographical areas.

A network interface 312 is provided to support communication between the network(s) 106 and the remote monitoring position 104. As a result, the particular form of the network interface 312 will depend on the type of network(s) 106 with which it must communicate.

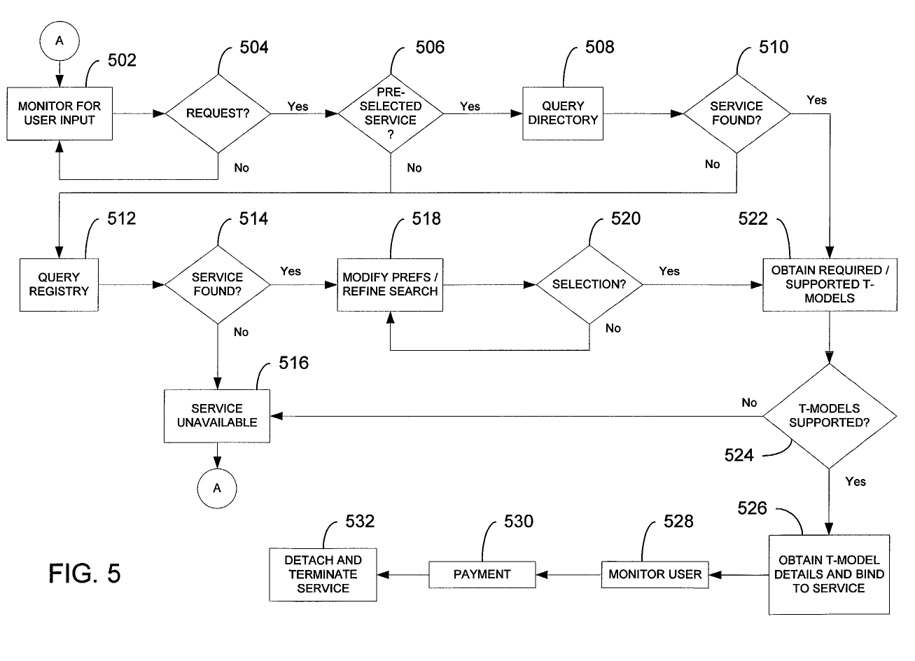

Referring now to FIG. 4, a generalized process for providing services in accordance with the present invention is illustrated. In particular, monitoring service provision is characterized by the four steps (and one optional step) illustrated in FIG. 4. At step 402, a monitoring service is initiated in the sense that a request for such a service is made. If such a service is not already known to be available, service discovery 404 may be performed to identify a suitable service. Assuming a suitable monitoring service is available, the monitoring service is invoked at step 406 and the actual monitoring service is delivered at step 408. Upon completion of the monitoring service, termination procedures 410 are performed. FIG. 5 illustrates a more detailed flowchart of one embodiment of the processing shown in FIG. 4.

At step 502, continuous monitoring of user input to a mobile wireless device is performed. At step 504, it is determined whether a request for remote monitoring has been initiated by a user of a mobile wireless device. The request can be provided, for example, through a voice interface or a simple push-button interface. In practice, voice recognition is accomplished using an engine such as ViaVoice by IBM. A voice recognition engine of this type can be used to recognize words during free-flow dictation or it can use grammar files with pre-defined query patterns in order to recognize simple commands.

At step 506, whether a monitoring service provider is already known and specified, e.g., in the user's preferences. If such a service has already been selected, processing can continue at step 508 where the invocation process begins, as described below. If such a service has not been previously determined, then a service provider must be dynamically discovered beginning at step 512.

At step 512, the service directory is queried by the mobile wireless device via the brokering application to find one or more appropriate services. In a presently preferred embodiment, such searches are performed on a directory that is compliant with the so-called Universal Description, Discovery and Integration (UDDI) initiative. The brokering application first selects a directory operator site to search. A UDDI-compliant directory allows businesses to list themselves along with services they provide. They can also list the technical blueprints (t-models) explaining how to bind to and invoke their services. Currently, public sites are hosted by Microsoft, IBM, and Hewlett-Packard without charge for listing or searching. Searches are performed using Extensible Markup Language (XML)/Simple Object Access Protocol (SOAP)-based query patterns and protocols specified in the UDDI 2.0 API specification. For example, the Microsoft UDDI software developer kit provides class wrappers for the XML/SOAP queries and responses and, in a preferred embodiment, is used to make these calls.

When searching for keywords, the brokering application can look at both names and taxonomies (categorizations) of both businesses and the services they provide, and can also search descriptions thereof. As applied to the instant invention, for example, the brokering application would look first at businesses categorized under “security” and then by their descriptions try to match them with other criteria from the user's preferences and location, such as coverage, price, etc.

When and if services matching the keyword(s) have been identified, at step 514, the brokering application sends information regarding the identified services to the mobile wireless device so that the user can choose to re-query using new/modified search parameters, at step 518, or choose to select one of the services at step 520.

If, at step 506, a particular service had been previously determined, processing continues at step 508 where the service directory is queried in order to find the service, i.e., how to contact the service provider. If the service is not available despite the information provided by the service directory, the service directory may be re-queried at step 512 as described above.

Regardless of the manner in which a service has been chosen, the mobile wireless device, via the brokering application, has to decide if it can bind to the selected service. In a presently preferred embodiment, this is accomplished by performing an XML/SOAP query, at step 522, that returns a list of the so-called t-models that designate how to bind to the service. When a user initiates a service request, it tells the brokering application what technical capabilities it supports (by way of a user profile which the brokering application can access). When the search results comes back, the brokering application compares the t-model information with the user profile. If the t-model(s) required are not supported by the user or mobile wireless device at step 524, then the user of the mobile wireless device is informed that the monitoring service is unavailable at step 516 therefore requiring further user interaction such that another choice can be made. If the t-model(s) specified are supported by the mobile device, then the brokering application gets the details of the service provider's particular implementation of them. At step 526, it then uses this information to bind the mobile wireless device to the monitoring service and begin the transaction.

Generally, t-models have unique identification numbers (UUIDs) and can be created by anyone registered with a UDDI server. A company could create t-models for its services, but it is far more useful to provide its own implementations of already extant, standardized t-models. This facilitates automatic invocation as the software on the mobile wireless device can be written with standard t-models in mind. Furthermore, supported t-models can include protocols, client software, and client hardware. For example, if a service provider wanted to provide a service through Microsoft NetMeeting, then it declares support for a standard t-model for binding using NetMeeting protocols and then describes its own instance of that t-model (the IP address to call, the type of call, camera/microphone required, etc.).

At step 528, the monitoring service begins monitoring of the mobile wireless device based on location-related information ascertained by the service provider (i.e., at the remote monitoring position). Delivery of the service is further described with reference to FIGS. 6 and 7 below. Once the service has been provided, payment takes place, at step 530, and is either automated through use of payment t-models (transmit credit card info, use internet payment service, etc.) along with a stored, local profile or is otherwise taken care of by interaction with the service provider. Thereafter, upon determining that the monitoring service is no longer needed, the user of the mobile wireless device, or the mobile wireless device itself, terminates the connection to the service provider in a manner consistent with the t-model specifications (hanging up the call, turning off the camera, etc.) and returns to its resting state (monitoring the audio stream for user interaction).

Referring now to FIG. 6, operation of a mobile wireless device in accordance with an embodiment of the present invention is further described. At block 602, the mobile wireless device receives a request for monitoring services via one of the available user input modalities, e.g., menu selection, button activation, voice recognition, etc. Additionally, at block 604, location-related information as described above is provided by the mobile wireless device, i.e., either directly or indirectly through another system. Regardless, the request and location-related information are provided to a monitoring service provider (as identified by the process described above relative to FIG. 5) at a remote monitoring position.

Assuming the necessary steps to allow the mobile wireless device to bind to the service provider have taken place, a variety of actions may take place. For example, the mobile wireless device may receive environmental information from the remote monitoring position, at block 608, which environmental information may be provided to a user of the mobile wireless device. Where the mobile wireless device is equipped with one or more additional environmental sensors itself, the mobile wireless device may provide additional environmental information, supplied by the additional environmental sensor(s), to the remote monitoring position at block 610. This may be useful in allowing the personnel at the remote monitoring position to understand the conditions currently being experienced by the user of the mobile wireless device.

As an enhanced level of service, audio information may be received from or sent to the remote monitoring position by the mobile wireless device, as indicated by block 612. In this manner, a user of the mobile wireless device may receive commentary from the monitoring personnel regarding the particular environmental conditions being monitored. Conversely, the existence of a reverse audio channel allows the monitoring personnel judge, for example, the relative comfort of the user of the mobile wireless device.

Further still, in the course of monitoring the environmental information provided to the remote monitoring position, the monitoring personnel may detect a situation or conditions that represent a potential security risk to the user of the mobile wireless device. To warn the user of this, the remote monitoring position can be operated to cause an alarm signal to be sent to the mobile wireless device, which signal is received at block 614. Thereafter, an indicia of the alarm signal is provided to the user of the mobile wireless device. The particular form of indicia used is a matter of design choice. For example, a simple approach may cause an light to flash or an annunciator (e.g., a buzzer or bell) to activate. In more complex implementations, the alarm signal may comprise a “canned” speech signal warning the user of the situation. Regardless of the implementation used, the alarm signal allows the monitoring personnel to interact with the user of the mobile wireless device in a manner previously unavailable.

Referring now to FIG. 7, operation of a remote monitoring position in accordance with an embodiment of the present invention is further described. In many respects, the operations illustrated in FIG. 7 are the compliment of those illustrated in FIG. 6. At block 702, the remote monitoring position receives the request for monitoring services from the mobile wireless device. Assuming the mobile wireless device is successfully able to bind to the monitoring service, the remote monitoring position ascertains the location-related information regarding the mobile wireless device at block 704. Where the mobile wireless device determines location information directly, this block is little more than a step of receiving the location information from the mobile wireless device. Conversely, where the mobile wireless device does not directly determine such information, but rather merely enables it to be determined by other systems, block 704 may require the remote monitoring position to actively seek the location-related information, for example, by polling a tracking system.

Regardless of the manner in which the remote monitoring position obtains the location-related information, it accesses a sensor registry, at block 706, to identify suitable environmental sensors based on the location-related information. Note that, in practice, this will be a continuous process as the mobile wireless device will most likely move, resulting in a stream of updated location-related information. As suitable environmental sensors are selected, the remote monitoring position receives, at step 708, environmental information from the selected environmental sensors.

Thereafter, a variety of actions may take place. At block 710, the remote monitoring position may provide at least a portion of the environmental information to the mobile wireless device. For example, where the environmental information comprises video images, the remote monitoring position can send video data corresponding to regions ahead of the mobile wireless device's current location (assuming a trajectory for the mobile wireless device can be determined) as well as regions behind the mobile wireless device's current location (again, assuming a trajectory can be determined). One embodiment of such “look-ahead” operation is to allow the user to inform the remote monitoring position that he/she is heading from Point A to Point B. Thereafter, the remote monitoring position can monitor the entire route or portions of the route to make sure it is safe to proceed. If not, the remote monitoring position can suggest an alternate route.

Where the mobile wireless device is equipped with one or more additional environmental sensors, the remote monitoring position may receive additional environmental information from the mobile wireless device at block 712. Additionally, as previously described, the remote monitoring position may transceive audio information with the mobile wireless device at block 714, or send an alarm signal to the mobile wireless device at block 716.

The present invention provides a technique for remotely monitoring a mobile wireless device as a means of providing a virtual personal escort. Previously, such personal escorts were beyond the financial reach of most individuals. However, the present invention provides an economical means of providing such services. While the present invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A system for providing remote monitoring, comprising:
at least one mobile wireless device, wherein location-related information can be determined for each mobile wireless device of the at least one mobile wireless device;
a remote monitoring position, in wireless communication with the at least one mobile wireless device, that ascertains the location-related information for a mobile wireless device of the at least one mobile wireless device; and
at least one environmental sensor, coupled to the remote monitoring position, that provides, to the remote monitoring position, environmental information regarding a region proximate to a location based on the location-related information.

2. The system of claim 1, wherein the remote monitoring position is coupled to the at least one environmental sensor via a communication network.

3. The system of claim 2, wherein the communication network comprises either of a World Wide Web and an Internet.

4. The system of claim 1, wherein the at least one environmental sensor comprises at least one camera.

5. The system of claim 1, wherein the mobile wireless device comprises an additional environmental sensor that wirelessly provides additional environmental information to the remote monitoring position.

6. The system of claim 5, wherein the additional environmental sensor comprises a camera.

7. The system of claim 1, wherein the mobile wireless device and the remote monitoring position communicate via at least one audio channel.

8. The system of claim 1, wherein the remote monitoring position wirelessly provides at least a portion of the environmental information to the mobile wireless device.

9. The system of claim 1, further comprising:
a registry, coupled to the remote monitoring position, comprising information regarding each of the at least one environmental sensor,
wherein the remote monitoring position selects the at least one environmental sensor based on the information regarding each of the at least one environmental sensor.

10. A mobile wireless device for use in providing remote monitoring, comprising:
input means for receiving, from a user of the mobile wireless device, a request for remote monitoring of the mobile wireless device;
means for providing location-related information corresponding to the mobile wireless device; and
means, coupled to the input means and the means for providing, for wirelessly sending the request and the location-related information to a remote monitoring position,
wherein the remote monitoring position monitors the mobile wireless device based on at least one environmental sensor substantially within a region proximate to a location based on the location-related information.

11. The mobile wireless device of claim 10, further comprising:
means, coupled to the means for wirelessly sending, for determining additional environmental information,
wherein the means for wirelessly sending sends the environmental information to the remote monitoring position.

12. The mobile wireless device of claim 11, wherein the means for determining the additional environmental information comprises a camera.

13. The mobile wireless device of claim 10, further comprising:
means for wirelessly receiving, from the remote monitoring position, at least a portion of the environmental information; and
means, coupled to the means for wirelessly receiving, for providing the at least a portion of the environmental information to a user of the mobile wireless device.

14. The mobile wireless device of claim 13, wherein the means for wirelessly receiving further function to receive audio information from the remote monitoring position.

15. The mobile wireless device of claim 10, wherein the means for wirelessly receiving further function to receive an alarm signal from the remote monitoring position, and wherein the mobile wireless device further comprises:
output means, coupled to the means for wirelessly receiving, for providing indicia of the alarm signal to a user of the mobile wireless device.

16. The mobile wireless device of claim 10, wherein the means for wirelessly sending further function to send audio information to the remote monitoring position.

17. A remote monitoring position for providing remote monitoring of a mobile wireless device, comprising:
first means for receiving, from the mobile wireless device, a request for remote monitoring of the mobile wireless device;
means for ascertaining location-related information of the mobile wireless device; and
second means for receiving environmental information from at least one environmental sensor within a region proximate to a location defined based on the location-related information.

18. The remote monitoring position of claim 17, further comprising:
means for accessing, based on the request, a registry comprising information regarding the at least one environmental sensor,
wherein the at least one environmental sensor is selected based on the location-related information and the information regarding the at least one environmental sensor.

19. The remote monitoring position of claim 17, wherein the first means for receiving further function to receive audio information from the mobile wireless device.

20. The remote monitoring position of claim 17, further comprising:
means for sending at least a portion of the environmental information to the mobile wireless device.

21. The remote monitoring position of claim 17, further comprising:
means for sending audio information to the mobile wireless device.

22. The remote monitoring position of claim 17, further comprising:
a user interface, coupled to the second means for receiving, for providing the environmental information to a user of the remote monitoring position.

23. The remote monitoring position of claim 17, further comprising:
means for sending an alarm signal to the mobile wireless device.

24. A method in a mobile wireless device for supporting remote monitoring of the mobile wireless device, the method comprising steps of:
receiving a request for remote monitoring of the mobile wireless device;
providing location-related information of the mobile wireless device; and
sending the request and the location-related information to a remote monitoring position,
wherein the remote monitoring position monitors the mobile wireless device based on at least one environmental sensor within a region proximate to a location based on the location-related information.

25. The method of claim 24, further comprising:
determining additional environmental information via an additional environmental sensor; and
sending the additional environmental information to the remote monitoring position.

26. The method of claim 24, further comprising:
receiving, from the remote monitoring position, at least a portion of the environmental information; and
providing the at least a portion of the environmental information to a user of the mobile wireless device.

27. The method of claim 24, further comprising:
receive audio information from the remote monitoring position.

28. The method of claim 24, further comprising:
receiving an alarm signal from the remote monitoring position; and
providing indicia of the alarm signal to a user of the mobile wireless device.

29. The method of claim 24, further comprising:
sending audio information to the remote monitoring position.

30. A method in a remote monitoring position for providing remote monitoring of a mobile wireless device, the method comprising:
receiving, from the mobile wireless device, a request for remote monitoring of the mobile wireless device;
ascertaining location-related information of the mobile wireless device; and
receiving, from at least one environmental sensor, environmental information, wherein the at least one environmental sensor is within a region proximate to a location based on the location-related information.

31. The method of claim 30, further comprising:
accessing, based on the request, a registry comprising information regarding the at least one environmental sensor,
wherein the at least one environmental sensor is selected based on the location-related information and the information regarding the at least one environmental sensor.

32. The method of claim 30, further comprising:
receiving audio information from the mobile wireless device.

33. The method of claim 30, further comprising:
sending at least a portion of the environmental information to the mobile wireless device.

34. The method of claim 30, further comprising:
sending audio information to the mobile wireless device.

35. The method of claim 30, further comprising:
providing the environmental information to a user of the remote monitoring position.

36. The method of claim 30, further comprising:
sending an alarm signal to the mobile wireless device.
